(19) United States
(12) Patent Application Publication
(10) Pub. No.: US 2024/0250258 A1
(43) Pub. Date: Jul. 25, 2024

(54) POSITIVE ELECTRODE ACTIVE MATERIAL FOR FLUORIDE ION BATTERY AND FLUORIDE ION BATTERY

(71) Applicant: TOYOTA JIDOSHA KABUSHIKI KAISHA, Toyota-shi Aichi-ken (JP)

(72) Inventor: Kousuke Noi, Uji-shi Kyoto-fu (JP)

(73) Assignee: TOYOTA JIDOSHA KABUSHIKI KAISHA, Toyota-shi Aichi-ken (JP)

(21) Appl. No.: 18/418,922

(22) Filed: Jan. 22, 2024

(30) Foreign Application Priority Data
Jan. 23, 2023 (JP) 2023-008171

(51) Int. Cl. H01M 4/58; H01M 4/38; H01M 4/86; H01M 10/0562

(52) U.S. Cl. CPC H01M 4/582; H01M 4/38; H01M 10/0562; H01M 2004/8689; H01M 2300/008

(57) ABSTRACT

Disclosed is a positive electrode active material capable of improving the energy density of a fluoride ion battery. The positive electrode active material for a fluoride ion battery of the present disclosure comprises copper selenide.

### CROSS-REFERENCE TO RELATED APPLICATIONS

This application claims priority to Japanese Patent Application No. 2023-008171 filed Jan. 23, 2023, the entire contents of which are herein incorporated by reference.

### TECHNICAL FIELD

The present application discloses a positive electrode active material for a fluoride ion battery and a fluoride ion battery.

### BACKGROUND ART

PTL 1 discloses copper sulfide (CuₓS, 1≤x≤2) as a positive electrode active material for a fluoride ion battery.

### CITATION LIST

### Patent Literature

[PTL 1] JP 2018-186067 A

### SUMMARY

### Technical Problem

The positive electrode active material for a fluoride ion battery disclosed in PTL 1 has room for improvement with respect to energy density.

### Solution to Problem

The present application discloses, as aforementioned solution to problem, the following plurality of aspects.

### <Aspect 1>

A positive electrode active material for a fluoride ion battery, comprising copper selenide.

### <Aspect 2>

The positive electrode active material of Aspect 1, wherein the copper selenide is Cu₂Se.

### <Aspect 3>

A fluoride ion battery, comprising: a positive electrode active material layer, an electrolyte layer, and a negative electrode active material layer, wherein
the positive electrode active material layer comprises a positive electrode active material of Aspect 1 or 2.

### <Aspect 4>

The fluoride ion battery of Aspect 3, wherein the electrolyte layer comprises a solid electrolyte.

### Effects

According to the positive electrode active material for a fluoride ion battery of the present disclosure, it is possible to improve the energy density of the fluoride ion battery.

### BRIEF DESCRIPTION OF DRAWINGS

FIG. 1 schematically shows an example of the configuration of a fluoride ion battery.

FIG. 2 shows the first charge and discharge curve of the evaluation cell according to Example 1.

FIG. 3 shows the first charge and discharge curves of the evaluation cell according to Comparative Example 1.

FIG. 4 shows the results of measuring the resistance after charging of each evaluation cell according to Example 1 and Comparative Example 1.

FIG. 5 shows the results of measuring the resistance after discharging of each evaluation cell according to Example 1 and Comparative Example 1.

### DESCRIPTION OF EMBODIMENTS

### 1. Positive Electrode Active Material for Fluoride Ion Batteries

The positive electrode active material for a fluoride ion battery of the present disclosure comprises copper selenide. Although details of the reaction mechanism of copper selenide in a fluoride ion battery are unclear, it is considered that copper selenide is fluorinated during charging of a fluoride ion battery and defluorinated during discharging. According to a new finding of the present inventor, a fluoride ion battery containing copper selenide as a positive electrode active material has a higher discharging potential and an electrochemical reaction in a positive electrode proceeds efficiently, and a specific capacity is increased. And as a result, an energy density (=∫(specific capacity×discharge potential)) is also improved because an overpotential (cell resistance) is reduced than a fluoride ion battery containing copper sulfide as a positive electrode active material.

The chemical composition of copper selenide is not particularly limited. Copper selenide may be a combination of compounds having different chemical compositions. Copper selenide may be as indicated by CuₓSe (0<x≤2.0). x may be 0.5 or more and 2.0 or less, or 1.0 or more and 2.0 or less. More specifically, copper selenide may be at least one selected from Cu₂Se, CuSe and CuSe₂. Among them, when copper selenide is Cu₂Se, the energy-density is easier to be significantly improved.

The shape of the positive electrode active material may be any shape that can function as a positive electrode active material of a fluoride ion battery. The positive electrode active material may be, for example, particulate. The mean particle diameter (D50) of the positive electrode active material particles may be, for example, 1 nm or more and 500 μm or less, 10 nm or more and 100 μm or less, or 20 nm or more and 50 μm or less. The mean particle diameter (D50) as referred to in the present application is the particle diameter (median diameter) at an integrated value of 50% in the particle size distribution on a volume basis determined by a laser diffraction/scattering method.

### 2. Positive Electrode Mixture for Fluoride Ion Batteries

The positive electrode mixture for a fluoride ion battery of the present disclosure includes copper selenide as a positive electrode active material. The positive electrode mixture may contain a positive electrode active material other than copper selenide together with copper selenide. Further, the positive electrode mixture may contain an electrolyte. Further, the positive electrode mixture may include a conductive material. Further, the positive electrode mixture may contain a binder. In one embodiment, the positive electrode mixture for a fluoride ion battery may include at least copper selenide as a positive electrode active material and an electrolyte. In one embodiment, the positive electrode mixture for a fluoride ion battery may include at least copper selenide as a positive electrode active material, an electrolyte, and a conductive material. In one embodiment, the positive electrode mixture for a fluoride ion battery may include at least copper selenide as a positive electrode active material, an electrolyte, a conductive material, and a binder.

### 2.1 Cathode Active Material

The content of the positive electrode active material in the positive electrode mixture may be, for example, 20% by mass or more and 100% by mass or less, 30% by mass or more and 100% by mass or less, or 40% by mass or more and 100% by mass or less. The positive electrode active material contained in the positive electrode mixture may be only copper selenide or may be a combination of copper selenide and a positive electrode active material other than copper selenide. As a positive electrode active material other than copper selenide, for example, a material known as a positive electrode active material for a fluoride ion battery such as copper sulfide can be employed. The ratio of copper selenide occupying the total (100% by mass) of the positive electrode active material contained in the positive electrode mixture may be, for example, 30% by mass or more and 100% by mass or less, 40% by mass or more and 100% by mass or less, 50% by mass or more and 100% by mass or less, 60% by mass or more and 100% by mass or less, 70% by mass or more and 100% by mass or less, 80% by mass or more and 100% by mass or less, 90% by mass or more and 100% by mass or less, 95% by mass or more and 100% by mass or less, 99% by mass or more and 100% by mass or less, or 100% by mass.

### 2.2 Electrolyte

The positive electrode mixture may contain an electrolyte. The electrolyte may be a solid electrolyte or a liquid electrolyte (electrolytic solution). In particular, when the positive electrode mixture contains a solid electrolyte, high performance is easily secured. The content of the solid electrolyte in the positive electrode mixture may be, for example, 0% by mass or more and 80% by mass or less, 0% by mass or more and 70% by mass or less, or 0% by mass or more and 60% by mass or less. The electrolyte may be only one kind or may be a combination of two or more kinds.

The solid electrolyte may be, for example, an inorganic solid electrolyte containing a metal element and a fluorine element. The inorganic solid electrolyte may contain only one kind of metal elements, or may contain two or more kinds thereof. The inorganic-solid electrolyte may be, for example, at least one selected from fluorides of lanthanoid elements such as La, Ce; fluorides of alkali elements such as Li, Na, K, Rb, Cs, and the like; fluorides of alkaline carth elements such as Ca, Sr, Ba, and the like. Specifically, it may be at least one selected from fluoride of La and Ba (e.g., La_{0.9}Ba_{0.1}F_{2.9}), fluoride of La and Sr (e.g., La_{0.95}Sr_{0.05}F_{2.95}), fluoride of Ca and Ba (e.g., Ca_{0.5}Ba_{0.5}F₂), fluoride of Pb and Sn, and etc. In one embodiment, the solid electrolyte may comprise at least La, Sr and F. In one embodiment, the solid electrolyte may comprise at least Ca, Ba and F. In one embodiment, the solid electrolyte may comprise at least Pb, Sn and F. The elemental fluorine in the solid electrolyte may function as a carrier fluoride-ion (F⁻). The shape of the solid electrolyte is not particularly limited. The solid electrolyte may be, for example, particulate.

The liquid electrolyte includes, for example, a solvent and a salt dissolved in the solvent. The solvent may be, for example, an organic solvent. The organic solvent may be any solvent capable of dissolving the salt. The organic solvent may be at least one of: glymes represented by R¹—O(CH₂CH₂O)ₙ—R² (wherein R¹ and R² independently represents an alkyl group having four or less carbon atoms or a fluoroalkyl group having four or less carbon atoms, and n is within a range of 2 to 10) such as triethylene glycol dimethyl ether (G3), tetraethylene glycol dimethyl ether (G4), and the like; cyclic carbonates such as ethylene carbonate (EC), fluoroethylene carbonate (FEC), difluoroethylene carbonate (DFEC), propylene carbonate (PC), and butylene carbonate (BC); and chain carbonates such as dimethyl carbonate (DMC), diethyl carbonate (DEC), and ethyl methyl carbonate (EMC). The organic solvent may be an ionic liquid. The salt to be dissolved in the above solvent may be, for example, a fluoride salt. The fluoride salt may be at least one selected from, for example, an inorganic fluoride salt, an organic fluoride salt, an ionic liquid, and the like. The inorganic fluoride salt may be, for example, XF (X is at least one selected from Li, Na, K, Rb and Cs). The organic fluoride salt may be one having an ammonium cation such as tetramethylammonium cation and a fluorine-content anion. The liquid electrolyte may include, for example, a solvent described above and a salt described above dissolved at a concentration of 0.1 mol or more and 40 mol or less or 1 mol or more and 10 mol or less with respect to the solvent 1 L.

### 2.3 Conductive Material

The positive electrode mixture may include a conductive material. The conductive material may be the one having an electronic conductivity. The conductive material may be only one kind or may be a combination of two or more kinds. The conductive material may be, for example, a carbon material. The carbon material as the conductive material may be, for example, at least one selected from carbon black such as acetylene black, furnace black and thermal black, graphene, fullerene, carbon nanotubes, and the like. The shape of the conductive material is not particularly limited. The conductive material may be, for example, particulate or fibrous.

### 2.4 Binder

The positive electrode mixture may contain a binder. The binder may be any one that is chemically and electrically stable in a fluoride ion battery. The binder may be only one kind or may be a combination of two or more kinds. The binder may be, for example, a fluorine-based binder such as a polyvinylidene fluoride (PVDF) based binder or a polytetrafluoroethylene (PTFE) based binder, or a rubber-based binder such as styrene-butadiene rubber (SBR)

### 2.5 Supplement

The positive electrode mixture may contain various additives other than the components described above. The positive electrode mixture can be obtained by mixing each of the above components. The mixing method is not particularly limited, and may be, for example, dry or wet mixing by a ball mill, or slurry kneading or the like. In addition, before mixing, a pre-grinding treatment of the positive electrode active material may be performed.

### 3. Fluoride Ion Battery

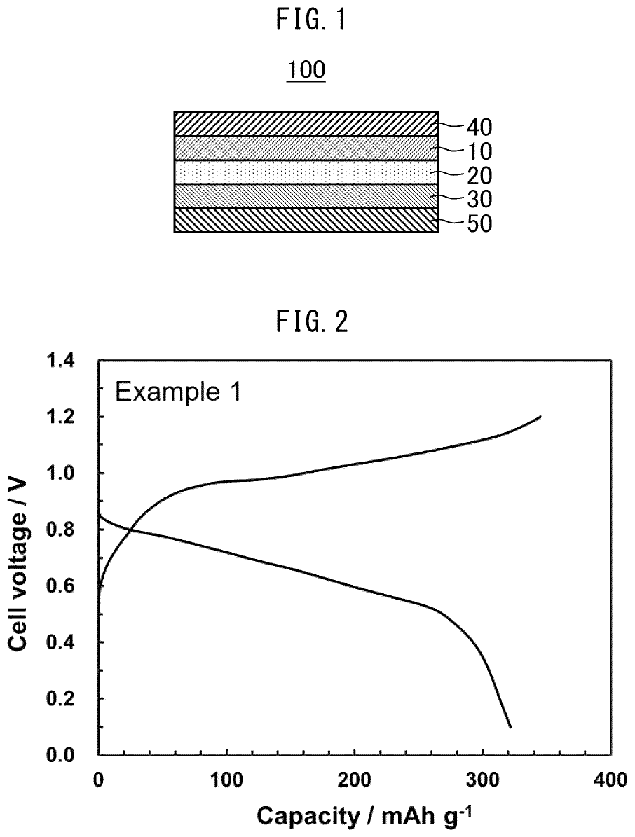

FIG. 1 schematically shows the configuration of the fluoride ion battery 100 according to one embodiment. The fluoride ion battery 100 has a positive electrode active material layer 10, an electrolyte layer 20, and a negative electrode active material layer 30. The positive electrode active material layer 10 includes a positive electrode active material of the present disclosure (that is, copper selenide).

### 3.1 Positive Electrode Active Material Layer

The positive electrode active material layer 10 may comprise, for example, the above-described positive electrode mixture. The shape of the positive electrode active material layer 10 is not particularly limited, and may be, for example, a sheet shape having a substantially planar surface. The thickness of the positive electrode active material layer 10 is not particularly limited, and may be an appropriate thickness depending on the configuration and the like of the fluoride ion battery 100. The positive electrode active material layer 10 may have, for example, a thickness of 100 nm or more and 1 mm or less.

### 3.2 Electrolyte Layer

The electrolyte layer 20 is disposed between the positive electrode active material layer 10 and the negative electrode active material layer 30. The electrolyte layer 20 includes at least an electrolyte. In one embodiment, the electrolyte layer 20 may include at least a solid electrolyte. In one embodiment, the electrolyte layer 20 may include a solid electrolyte and a binder. In one embodiment, the electrolyte layer 20 may include a liquid electrolyte and a separator for holding the liquid electrolyte.

The electrolyte contained in the electrolyte layer 20 may be a solid electrolyte or a liquid electrolyte. In particular, when the electrolyte layer 20 includes a solid electrolyte, high performance is easily secured. The electrolyte may be only one kind or may be a combination of two or more kinds. The solid electrolyte or the liquid electrolyte may be appropriately selected from those exemplified as those which may be included in the positive electrode mixture described above. The electrolyte that may be contained in the positive electrode mixture and the electrolyte that is contained in the electrolyte layer 20 may be of the same type or may be of different types.

The binder which may be contained in the electrolyte layer 20 may be only one kind or may be a combination of two or more kinds. The binder may be appropriately selected from those exemplified as those which may be included in the positive electrode mixture described above. The binder which may be contained in the positive electrode mixture and the binder which may be contained in the electrolyte layer 20 may be the same type or different types.

When the electrolyte layer 20 has a separator for holding a liquid electrolyte, any of the separators well known as a separator of a fluoride ion battery can be adopted.

The electrolyte layer 20 may be partially formed into the negative electrode active material layer 30 by charging. Specifically, the electrolyte layer 20 may be one in which a defluorination reaction of metal fluoride as a solid electrolyte occurs at an interface between the electrolyte layer 20 and the negative electrode current collector 50 during charging of the fluoride ion battery 100, and a metal layer (e.g., a Pb layer) as a negative electrode active material layer 30 may be generated at the interface.

The shape of the electrolyte layer 20 is not particularly limited, and may be, for example, a sheet shape having a substantially planar shape. The thickness of the electrolyte layer 20 is not particularly limited, and may be an appropriate thickness depending on the configuration and the like of the fluoride ion battery 100. The electrolyte layer 20 may have thickness of, for example, 100 nm or more and 1 mm or less.

### 3.3 Negative Electrode Active Material Layer

The negative electrode active material layer 30 includes at least a negative electrode active material. The negative electrode active material layer 30 may include at least one of an electrolyte, a conductive material, and a binder together with the negative electrode active material. The content of each component in the negative electrode active material layer 30 may be the same as in the prior art.

The negative electrode active material contained in the negative electrode active material layer 30 may be, for example, at least one selected from a metal, an alloy, a metal oxide, a metal fluoride, a carbon material, and a polymer material. Metallic elements constituting the negative electrode active material, may be, for example, at least one of La, Ca, Al, Eu, Li, Si, Ge, Sn, In, V, Cd, Cr, Fc, Zn, Ga, Ti, Nb, Mn, Yb, Zr, Sm, Ce, Mg and Pb. The carbon material constituting the negative electrode active material may be, for example, at least one of graphite, coke, and carbon nanotubes. The polymer material constituting the negative electrode active material may be at least one of polyaniline, polypyrrole, polyacetylene and polythiophene.

The electrolyte contained in the negative electrode active material layer 30 may be a solid electrolyte or a liquid electrolyte. In particular, when the negative electrode active material layer 30 includes a solid electrolyte, high performance is easily secured. The electrolyte may be only one kind or may be a combination of two or more kinds. The solid electrolyte or the liquid electrolyte may be appropriately selected from those exemplified as those which may be included in the positive electrode mixture described above. The electrolyte which may be contained in the positive electrode mixture and the electrolyte which may be contained in the negative electrode active material layer 30 may be of the same type or of different types.

The conductive material that may be included in the negative electrode active material layer 30 may be only one kind or may be a combination of two or more kinds. The conductive material may be appropriately selected from those exemplified as those which may be included in the positive electrode mixture described above. The conductive material which may be contained in the positive electrode mixture and the conductive material which may be contained in the negative electrode active material layer 30 may be the same type or different types.

The binder which may be contained in the negative electrode active material layer 30 may be only one kind or may be a combination of two or more kinds. The binder may be appropriately selected from those exemplified as those which may be included in the positive electrode mixture described above. The binder which may be contained in the positive electrode mixture and the binder which may be contained in the negative electrode active material layer 30 may be the same kind or different kinds.

The shape of the negative electrode active material layer 30 is not particularly limited, and may be, for example, a sheet shape having a substantially planar surface. The thickness of the negative electrode active material layer 30 is not particularly limited, and may be an appropriate thickness depending on the configuration and the like of the fluoride ion battery 100. The negative electrode active material layer 30 may have, for example, a thickness of 100 nm or more and 1 mm or less.

### 3.4 Other Configuration

The fluoride ion battery 100 may have a positive electrode current collector 40 electrically connected to the positive electrode active material layer 10 and a negative electrode current collector 50 electrically connected to the negative electrode active material layer 30. The positive electrode current collector 40 and the negative electrode current collector 50 may be the same as those known in the art, and various current collectors such as a foil shape, a mesh shape, and a porous shape may be employed.

The fluoride ion battery 100 may be an all-solid battery containing no liquid component or a battery containing a liquid component. Further, the fluoride ion battery 100 may be a primary battery or a secondary battery. In addition, the shape of the fluoride ion battery 100 may be, for example, a coin type, a laminate type, a cylindrical type, or a square type. The fluoride ion battery 100 can be easily manufactured through molding or the like of each of the above-described layers in a dry or wet manner.

### 4. Vehicle Having Fluoride Ion Battery

As described above, according to the technique of the present disclosure, the energy density of a fluoride ion battery can be improved. Such a fluoride-ion battery can be suitably used, for example, in at least one vehicle selected from a hybrid vehicle (HEV), a plug-in hybrid vehicle (PHEV) and an battery electric vehicle (BEV). In other words, the technique of the present disclosure has an aspect of vehicle having a fluoride ion battery, wherein the fluoride ion battery has a positive electrode active material layer, an electrolyte layer, and a negative electrode active material layer, and the positive electrode active material layer includes copper selenide as a positive electrode active material. Details of copper selenide as a positive electrode active material and a fluoride ion battery are as described above.

### EXAMPLES

Hereinafter, the technique of the present disclosure will be described in further detail with reference to Examples, but the technique of the present disclosure is not limited to the following Examples.

### 1. Example 1

### 1.1 Preparation of Positive Electrode Mixture

Solid-state electrolytes consisting of powdered Ca_{0.5}Ba_{0.5}F₂ (50CaF₂·50BaF₂ (mol %)) were obtained by mixing and reacting CaF₂ and BaF₂ by mechanical milling using a ball mill device (Flittu Co., planetary gear ball mill premium-line PL-7). The mechanical milling was carried out for 20 hours at a rotational speed 600 rpm, in a dry-argon atmosphere.

A powder positive electrode mixture was obtained by mixing the above solid electrolyte, copper selenide as a positive electrode active material (Cu₂Se, Mitsuwa Chemical Industries), and acetylene black as a conductive material, by mechanical milling using a ball mill device (manufactured by Flichu Co., planetary gear ball mill premium line PL-7). The mechanical milling was carried out for 3 hours at a rotational speed 600 rpm, in a dry-argon atmosphere. The composition of the positive electrode mixture was a mass ratio of positive electrode active material:solidelectrolyte:conductive material=40:55:5

### 1.2 Fabrication of Fluoride Ion Battery

Mixtures of PbF₂ powder as a negative electrode active material and acetylene black powder as a conductive material were prepared. The acetylene black in the mixture was 5% by mass based on the entire mixture. 50 mg of the mixture was press formed to obtain a body A which is a negative electrode active material layer.

100 mg of the solid electrolyte powder composed of the above-mentioned Ca_{0.5}Ba_{0.5}F₂ was press formed to obtain a body B which is the electrolyte layer.

15 mg of the positive electrode mixture described above was press formed to obtain a body C which is a positive electrode active material layer.

An all-solid fluoride ion battery was manufactured by laminating an aluminum foil as a negative electrode current collector, the body A (negative electrode active material layer), the body B (electrolyte layer), the body C (positive electrode active material layer), and a platinum foil as a positive electrode current collector in this order. The diameter of the all-solid fluoride ion battery (diameter of the electrode surface) was φ11.28 mm. The produced all-solid fluoride ion battery was placed in a cylindrical container having an inner diameter of 11.28 mm made of ceramics, and was sandwiched and fixed by stainless-steel cylinders having a diameter of 11.28 mm from both sides of the negative electrode current collector and the positive electrode current collector.

### 2. Comparative Example 1

A powdery positive electrode mixture and an all-solid fluoride ion battery were obtained in the same manner as in Example 1, except that copper sulfide (Cu₂S) was used instead of copper selenide as a positive electrode active material.

### 3. Evaluation of Fluoride Ion Batteries

Each of the all-solid fluoride ion batteries was charged and discharged once in the condition of a current density of 0.05 mA/cm² and a test temperature of 140° ° C. while being vacuumed in a closed vessel. The charge termination voltage and discharge termination voltage were set at 1.2V and 0.1V, respectively. Further, after completion of the charging and discharging, after the rest for 15 minutes, the resistance measurement of the battery by the AC impedance measurement was performed. The AC amplitude was 10 mV and the frequency ranged from 100 kHz to 0.1 Hz. For the charge/discharge test and the AC impedance measurement, an electrochemical measurement system equipped with a frequency-response analyzer (VMP-300 high-performance electrochemical measurement system manufactured by Biologic Co., Ltd.) was used.

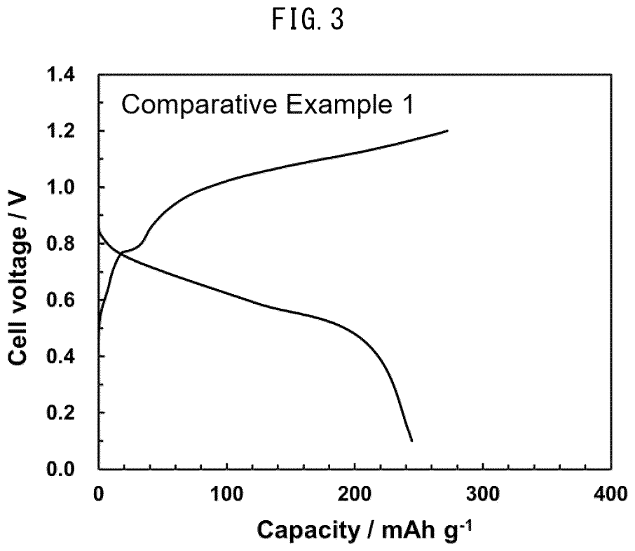

Table 1, FIG. 2 and FIG. 3 shows the results of the charge-discharge test. FIG. 2 is the result for Example 1, and FIG. 3 for comparative example 1. In Table 1, the “average discharge voltage” is a voltage when indicating the capacity of half of the discharge capacity. Further, “energy density” is an energy density per mass of a positive electrode active material, and is obtained by calculating an area of a region surrounded by a discharge curve and an x-axis using an analysis software (manufactured by Biologic Co., Ltd., EC-Lab)

TABLE 1

| | Positive | Discharge | Average | Energy |
|---|---|---|---|---|
| | electrode | capacity | discharge | density |
| | active material | (mAh/g) | voltage (V) | (Wh/kg) |
| Ex.1 | Cu₂Se | 321.1 | 0.649 | 200.5 |
| Comp. | Cu₂S | 244.4 | 0.589 | 141.4 |
| Ex. 1 | | | | |

As shown in Table 1, FIG. 2 and FIG. 3, Example 1 using copper selenide as a positive electrode active material had high discharge capacity, high average discharge voltage and high energy density as compared with Comparative Example 1 using copper sulfide.

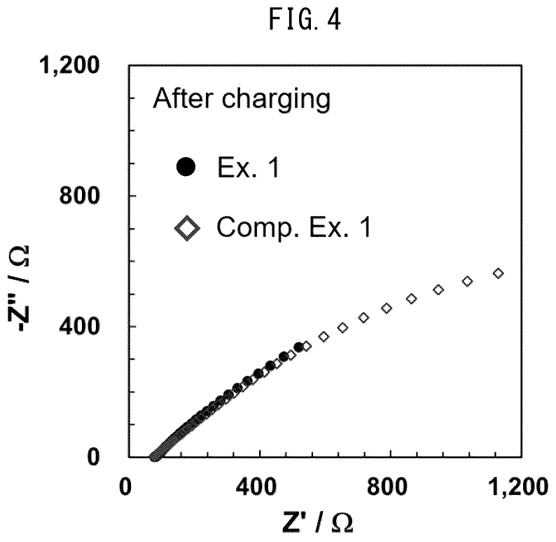

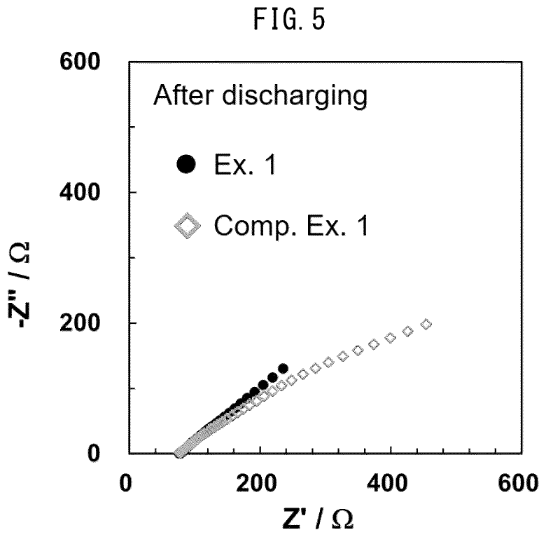

Table 2, FIG. 4 and FIG. 5 show the results of resistance measurement. FIG. 4 is a resistance measurement result after charging, FIG. 5 is a resistance measurement result after discharging. In Table 2, post-charge resistance and post-discharge resistance is measured by reading the resistance of the low frequency end (0.1 Hz) in the impedance plot.

TABLE 2

| | Positive | Post-charge | Post-discharge |
|---|---|---|---|
| | electrode | resistance | resistance |
| | active material | (Ω) | (Ω) |
| Ex. 1 | Cu₂Se | 518 | 235 |
| Comp. | Cu₂S | 1128 | 453 |
| Ex. 1 | | | |

As shown in Table 2, FIG. 3 and FIG. 4, Example 1 using copper selenide as a positive electrode active material had low resistance both after charging and after discharge, as compared with Comparative Example 1 using copper sulfide.

The high energy density of Example 1 is interpreted as a result of reduced battery overvoltage due to low resistance. That is, it is presumed that the discharge voltage becomes higher, and the discharge capacity is increased, as a result that the electrode reaction has progressed efficiently.

As described above, it has been found that when copper selenide is used as the positive electrode active material of the fluoride ion battery, the energy density of the fluoride ion battery is improved more than when copper sulfide is used.

In the above example, a case in which Cu₂Se is used as copper selenide is exemplified, but the composition of copper selenide is not limited thereto. Copper selenide having various compositions can be synthesized by using any two or more kinds of materials selected from a single Cu and Se, Cu₂Se, CuSe, and the like in a predetermined ratio. Examples of the method for synthesizing copper selenide include mechanical milling (mechanochemical reaction) and the like. Copper selenide need not be a single compound, but may contain one or more kinds of copper selenides.

In the above example, a case in which a solid electrolyte and a conductive material is used together with a positive electrode active material in the positive electrode mixture is exemplified, but the constituent components of the positive electrode mixture are not limited thereto. The positive electrode mixture may contain at least a positive electrode active material, and may optionally contain other components.

In the above example, an all-solid battery is exemplified as a fluoride ion battery, but the configuration of the fluoride ion battery is not limited thereto. It is considered that, even in a fluoride ion battery containing various liquids such as a liquid electrolyte, an energy density improving effect can be obtained by using copper selenide as a positive electrode active material.

### REFERENCE SIGNS LIST

10 Positive electrode active material layer
20 Electrolyte layer
30 Negative electrode active material layer
40 Positive electrode current collector
50 Negative electrode current collector
100 Fluoride ion battery

1. A positive electrode active material for a fluoride ion battery, comprising copper selenide.

2. The positive electrode active material according to claim 1, wherein
the copper selenide is Cu₂Se.

3. A fluoride ion battery comprising a positive electrode active material layer, an electrolyte layer, and a negative electrode active material layer, wherein
the positive electrode active material layer comprises a positive electrode active material according to claim 1.

4. The fluoride ion battery according to claim 3, wherein:
the electrolyte layer comprises a solid electrolyte.
